(19) United States
(12) Patent Application Publication
(10) Pub. No.: US 2018/0318877 A1
(43) Pub. Date: Nov. 8, 2018

(54) Composite particles, coatings and coated articles

(71) Applicant: UCL BUSINESS PLC, London, Greater London (GB)

(72) Inventors: Ivan Paul Parkin, Milton Keynes Buckinghamshire (GB); Claire Jane Carmalt, Rickmansworth Hertfordshire (GB); Yao Lu, London, Greater London (GB)

(21) Appl. No.: 15/770,410

(22) PCT Filed: Oct. 24, 2016
(86) PCT No.: PCT/GB2016/053313

§ 371 Date: Apr. 23, 2018

(30) Foreign Application Priority Data
Oct. 23, 2015 (GB) 1518826.1

(51) Int. Cl. B05D 5/08

(52) U.S. Cl. CPC B05D 5/086; B05D 2451/00; B05D 2401/32; B05D 2202/00; B05D 2601/00; B05D 2602/00; B05D 2401/60

(57) ABSTRACT

The invention relates to composite particles, coatings, and coated articles. An article is provided at least partially covered with a coating defining a slippery surface. The coating comprises a layer of particulate material bound to the article and a substantially immobilised lubricant at least partially covering and penetrating into the layer of composite particulate material. The composite particulate material comprises a carrier particle at least partially coated with a hydrophobic material. A further article is provided at least partially covered with a coating comprising a layer of the composite particulate material bound to said article. This is useful in preparation of the article having a coating defining a slippery surface. Methods of preparing the coating and the articles are also provided.

The invention relates to composite particles, coatings comprising composite particles and methods of preparing the same.

Slippery liquid infused porous surfaces (SLIPS) are surfaces that can repel a variety of solids and liquids, including water and oils. A SLIPS comprises a lubricant disposed on a substrate which has a morphology that renders it capable of immobilising the lubricant. The lubricant forms a substantially smooth, flat, low-friction surface that has substantially no surface defects. Owing to the liquid repulsion properties of the lubricant, SLIPS are also slippery in nature. That is to say, liquid droplets forming on the surface are able to slide. The more slippery the surface, the easier it is for the droplets to slide. Such surfaces were first reported by Wong et al. (Wong et al., Nature, 2011, 477, 443).

SLIPS can be self-cleaning. Whilst it is possible for certain materials to foul the surface, such contaminants may be easily removed by the sliding action of liquid droplets on the surface. Thus, when a liquid contacts the surface it forms droplets that slip on the surface. The slipping motion picks up and removes deposited contaminants, such as dirt, viruses and bacteria. SLIPS may repel a variety of liquids, including both water and oils, and they may thus be described as amphiphobic surfaces.

SLIPS have many potential applications, but there are relatively few reports of artificial SLIPS. Furthermore, a common problem with known SLIPS is that they lack robustness and durability. Some artificial SLIPS can exhibit self-repairing properties. Light damage to the substrate results in the lubricant migrating into the damaged region, thus maintaining a smooth lubricant surface. However, moderate impact or wear can result in catastrophic failure of the underlying substrate and hence destruction of the SLIPS. For example, current SLIPS can be irreversibly damaged by impact, abrasion and shear forces. This fundamental lack of robustness can be due to the weakness of the association between the substrate and the article, and also the intrinsic weakness of the substrate itself.

Typically, the substrates that are used for the formation of SLIPS comprise many nano and microstructures that create cavities, voids and pores. The substrates can be formed using a variety of methods, as described in WO 2012/100099 and various other publications¹⁻⁵. For example, existing substrates can be made from Teflon nanofibres, replica moulding and by roughening a surface using etching techniques. The substrates are often functionalised by coating it with fluorosilanes and the like. The lubricant wicks into the substrate, filling the spaces formed by the nano and microstructures, and becomes immobilised. However, the nano and microstructures are typically mechanically weak and can easily be damaged. Once damaged, the substrate can no longer immobilise the lubricant and so the lubricant has a tendency to leak, thus destroying the SLIPS. There is therefore a need for robust SLIPS.

In addition to their mechanical weakness, current SLIPS also lack durability because the lubricant can evaporate. As the lubricant evaporates, the underlying substrate becomes exposed and the SLIPS loses its slippery properties. It is difficult to prevent evaporation of the lubricant and even a small amount of evaporation can lead to the SLIPS losing slippery properties. Hence, there is a need for a durable SLIPS that retains its slippery, low-friction properties even after some of the lubricant has evaporated.

It is an object of the invention to overcome at least some of the above-mentioned disadvantages associated with SLIPS.

According to a first aspect of the invention, there is provided an article at least partially covered with a coating defining a slippery surface, the coating comprising a layer of a composite particulate material bound to said article and a substantially immobilised lubricant at least partially covering and penetrating into said layer of composite particulate material, wherein the composite particulate material comprises a carrier particle at least partially coated with a hydrophobic material.

The composite particulate material may be similar to that described by Lu et al. (Science, 2015, 347, 1132). That is to say, the composite particulate material may comprise dual-scale nanoparticles of titanium dioxide (the carrier particle) that are coated with perfluorooctyltriethoxysilane (the hydrophobic material). Owing to their small size, these nanoscale particles can be arranged on the article in such a way that nano and microstructures are formed by the agglomeration (by electrostatic forces and the like) of the nanoparticles. The lubricant can penetrate into the voids and cavities formed by these structures and can thus be immobilised. The inventors have found that by binding this particular composite particulate material to an article, the result is a coating that is substantially robust, as it is difficult to remove the composite particulate material from the surface of the article.

The inventors have also discovered that larger carrier particles which have a relatively rough surface and recess defining surface irregularities can effectively bind with the hydrophobic material to form the composite particulate material. In this case, the hydrophobic material is located at least partially within some or all of the recesses defined by the surface irregularities. It has surprisingly been found that, where the coating comprises such carrier particles, the resultant coating is even more robust.

It is thought that the larger size and surface characteristics of these carrier particles contributes to this enhanced robustness. Where very small carrier particles are employed (such as the nanoscale particles described by Lu et al.), the small size and low mass of the particles, along with the weak attractive forces between them, renders the nano and microstructures that are formed more fragile and susceptible to damage and destruction by mechanical impact, abrasion and the like.

By contrast, larger particles can have their own individual surface morphology that comprises nano or microstructures, which are difficult to damage. The larger individual carrier particles are more difficult to cleave or break apart and they are thus capable of retaining the nano or microstructures and the hydrophobic material, even after being subjected to very harsh environments. For example, the inventors have found that the composite particles retain the hydrophobic material even after grinding them in a pestle and mortar.

In particularly preferred embodiments, the composite particulate material is a powder or granular material. As discussed, the size can have an effect on the overall robustness of the coating and a variety of different size particles can be used. For example, the average size of the carrier particle may between about 20 nm and 300 μm.

The size of the carrier particle may be determined using sieve analysis and given as a mesh designation. There are a variety ways that the mesh size can be quoted, which are well known to a person skilled in the art. For example, common standards are the US standard sieve series and Tyler mesh size.

The carrier particles can have a size of −400 mesh or between −50 and +400, between −60 and +325, between −70 and +270, between −80 and +230, between −100 and +200, between −120 and +170, or between −120 and +140 mesh (US sieve series).

Where particle sizes are provided herein as (average) particle diameter or (average) particle size, this may refer to average particle size as determined by sieve series analysis.

In preferred embodiments, the composite particulate material comprises, or consists of, two particle populations having different average particle sizes. In particular, the composite particulate material preferably comprises a first particulate population having a relatively larger particle size, e.g. an average particle size of between about 100 nm and about 2000 μm, preferably between about 100 nm and about 2000 μm, preferably between about 40 μm and about 1000 μm, preferably between about 40 μm and about 350 μm, preferably between about 100 μm and about 1000 μm, and a second particulate population having a relatively smaller particle size than the first population, e.g. an average particle size of between about 10 nm and about 50 μm, preferably between about 10 nm and about 1 μm, preferably between about 10 nm and about 500 nm, preferably between about 10 nm and about 300 nm.

In some preferred embodiments, the particulate material further comprises a third particle population having an intermediate particle size (between the relatively smaller and relatively larger particles mentioned above), e.g. an average particle size of between about 50 nm and about 100 μm, preferably between larger than about 1 μm and about 100 μm, preferably between about 10 μm and up to about 100 μm.

When the composite particulate material includes two particle populations having different particle sizes, e.g. having two different particle sizes as noted above, it is thought that the particulate material having the larger particle size may act to immobilise the particulate material having the smaller particle size, for example immobilisation of the smaller particles in between the larger particles on the surface. This immobilisation effect is particularly noted where the larger particles have a rough surface morphology; in which case, the larger particles act more effectively to immobilise the smaller particles in the spaces at the surface between the larger particles. This immobilisation has the benefit of improving the robustness and physical durability of the composite particulate material coating on the surface which results in a more durable SLIPS surface when a suitable lubricant (e.g. as defined herein) is added.

The immobilisation of the composite particulate material at the surface is particularly effective when the composite particulate material comprises or consists of three particle populations having different particle sizes, e.g. having three different particle sizes as noted above. In these embodiments, particulate material populations may be referred to as “large”, “medium”, and “small” due to their relative sizes. In these embodiments, the “small” particulate material is thought to be immobilised in the spaces at the surface between the “medium” and “large” particles so further improving the robustness and physical durability of the composite particulate material coating and resulting in a more durable SLIPS surface when a suitable lubricant (e.g. as defined herein) is added.

Preferably, the carrier particle is substantially robust and non-friable, that is to say it is made from a hard material that is substantially resistant to deformation or fragmentation.

The carrier particle can comprise or consist of a natural or synthetic mineral, a metal, metal alloy, metal oxide, or metal salt, or a mixture or composite of any of these. The term “metal” encompasses all the metals of the periodic table. Thus, the metal can be an f-block (lanthanide or actinide), d-block (including all transition metals), s-block or p-block metal.

In preferred embodiments, the metal is aluminium, chromium, cobalt, copper, iron, manganese, silver, tin, niobium, titanium, lead, nickel, zinc, or molybdenum, and it is preferably in the form of or within an oxide, mixture, alloy, natural or synthetic mineral or composite.

Alternatively or in addition, the carrier particle can comprise or consist of a silicon, beryllium, boron, phosphorus, or arsenic compound, or an oxide of any of these.

In some preferred embodiments, the carrier particle populations can comprise or consist of one or more materials selected from: MnO, SiC, Al₂O₃, Fe, Fe₂O₃, Fe₃O₄, Ni, Nb₂O₅, Ta₂O₅, TiO₂, SiO₂, Cu, CuO, Cu₂O, CaCO3, MgO, Zn, and ZnO

In embodiments where the composite particulate material comprises or consists of two particle populations as described above, the carrier particles in each population may comprise or consist of any of the materials described above. In some preferred embodiments the relatively larger carrier particles are preferably selected from one or more of MnO, SiC, and Al₂O₃ preferably MnO. In some preferred embodiments the relatively smaller carrier particles are preferably selected from one or more of Fe, Fe₂O₃, Fe₃O₄, Ni, Nb₂O₅, TiO₂, SiO₂, Cu, and CaCO₃, preferably Fe or Nb₂O₅.

In some embodiments where the composite particulate material comprises or consists of three particle populations as described above, the carrier particles in each population may comprise or consist of any of the materials described above. In some preferred embodiments the relatively “large” carrier particles are preferably selected from one or more of MnO, SiC, and Al₂O₃ preferably MnO. In some preferred embodiments the relatively “medium” carrier particles are preferably selected from one or more of Fe, Fe₂O₃, Fe₃O₄, Ni, Cu, and CaCO₃, preferably Fe. In some preferred embodiments the relatively “small” carrier particles are preferably selected from one or more of Nb₂O₅, TiO₂, SiO₂, Cu, and CaCO₃, preferably Nb₂O₅.

In some preferred embodiments, the composite particulate material comprises or consists of three carrier particle populations including:

MnO particles having an average particle size of between about 100 μm and about 1000 μm, such as between about 100 μm and about 500 μm, preferably between about 100 μm and about 250 μm, for example having a particle size distribution between about 88 μm and about 250 μm;

Fe particles having an average particle size of between about 10 μm and up to about 100 μm; and

Nb₂O₅ particles having an average particle size of between about 10 nm and about 50 μm, for example having a particle size less than about 44 μm.

In some embodiments described herein, Ta₂O₅ may be used instead of Nb₂O₅ in any aspects of the invention.

This combination of materials and particle sizes is found to have particularly beneficial durability leading to durable SLIPS when a suitable lubricant component (e.g. as defined herein) is added.

It should be well understood that the hydrophobic material is preferably strongly bound to the carrier particle to form the composite particulate material. The hydrophobic material may coat the entire surface of the carrier particle or it may form a discontinuous coating on the surface of the carrier particle. The hydrophobic material can be any compound that is hydrophobic in nature and able to combine with the carrier particle to form the composite particle. For example, the hydrophobic material can be a functionalised hydrocarbon, fluorocarbon or a combination thereof, or it can be a polymer which has a chain comprising carbon, silicon and fluorine atoms. Particularly preferred hydrophobic materials are silanes, fluorosilanes, perfluorosilanes, organosilicon compounds (including silicones and polymerised siloxanes), fluorocarbons, perfluorocarbons, fluorinated carboxylic acids and esters, perfluorinated carboxylic acids and esters, fatty acids, fatty esters (including mono-, di and triglycerides), and derivatives and salts thereof.

In certain embodiments, the hydrophobic material is perfluorooctyltriethoxysilane or poly(tetrafluoroethylene) (PTFE). Alternatively, the hydrophobic material can be a fluorinated or perfluorinated carboxylic acid, such as perfluorooctanoic acid or a mixture or salt thereof. In some embodiments, the hydrophobic material is a polymeric organosilicon compound such as polydimethylsiloxane (PDMS).

The hydrophobic material can be a fatty acid or a fatty acid salt or derivative. This may be particularly advantageous because fatty acids are considered by many to be more environmentally-friendly compared with fluoro or perfluoro compounds. The fatty acid can be a short- or long-chain saturated or unsaturated fatty acid, and it can be branched or straight chained. The aliphatic component or chain of the fatty acid can include between about 4 and about 35 carbon atoms, preferably between about 10 and about 20 carbon atoms. Fatty esters (more commonly known as mono-, di and triglycerides) can also be used. In preferred embodiments, the hydrophobic material can be perfluorooctyltriethoxysilane, lauric, myristic, palmitic, octadecanoic acid (stearic acid), a derivative or salt thereof, or a mixture of any of these.

The characteristics of the carrier particle and the hydrophobic material can provide the composite particulate material with pigmentation. For example, if the carrier particle is iron (III) oxide, which is naturally red/brown, then the composite particulate material may also be red/brown. Similarly, if the hydrophobic material is pigmented then this may also impart the composite particulate material with some pigmentation. In alternative embodiments, the composite particulate material is substantially devoid of any pigmentation. For example, the composite particulate material is white or at least partially clear. This can provide the final coating with a particular colouring.

The composite particulate materials can be manufactured by mixing the hydrophobic material and the carrier particle with a carrier liquid and subsequently removing the carrier liquid. Preferably, the method comprises mixing the hydrophobic material and a plurality of the carrier particles with the carrier liquid.

The carrier liquid can comprise ethanol, methanol, isopropyl alcohol, butyl alcohol, pentanol, ethyl acetate, acetone, water or a mixture of any of these. The carrier liquid can also comprise a chlorinated liquid, such as chloroform, dichloromethane or dichloroethane. The hydrophobic material should be at least partially soluble in the carrier liquid and therefore addition of the hydrophobic material to the carrier liquid can form a solution.

The method of preparing the composite particulate material may comprise at least partially dissolving the hydrophobic material in the carrier liquid to form a solution, then adding a plurality of the carrier particles of the first aspect of the invention to the solution and finally removing the carrier liquid to provide the composite particulate material.

According to a particular method, the hydrophobic material is mixed in the carrier liquid until it has dissolved. The dissolution of the hydrophobic material may be encouraged by agitating the solution. Next, a plurality of the carrier particles is added to the mixture. This forms a mixture comprising the carrier particles, hydrophobic material and the carrier liquid. It is desirable to ensure that the carrier particles are adequately dispersed in the mixture, which may be facilitated by stirring the mixture. The carrier liquid is then removed using any suitable means. The carrier liquid can be removed by filtering the mixture and then evaporating the residual carrier liquid from the material deposited on the filter medium. Alternatively, the carrier liquid can be removed solely via evaporation.

Where the composite particulate material is a powder or granular composition it can be free-flowing.

The composite particulate material can be hydrophobic, i.e. the composite particles can repel water. The composite particulate material may retain such hydrophobic properties even after exposure to harsh conditions. For example, the composite particulate material may retain its hydrophobic properties even after being ground using a pestle and mortar or exposed to radiation, such as ultraviolet (UV) radiation (see Example 2, Table 1). It is thought that this substantial robustness comes about because the carrier particle is substantially non-friable and hard. It is therefore extremely difficult to disrupt the carrier particle and damage the surfaces structures or dislodge the hydrophobic material from the recesses of the carrier particle. The high degree of robustness of the composite particulate material contributes to the excellent robustness of the final coated material.

The properties of the article itself (such as its chemical and/or physical properties), may enable it to bind with the composite particulate material. Alternatively, it may, in some embodiments, be desirable to establish the strong bond by employing a binder to strongly bind the composite particulate material to the article. Thus, in some embodiments, the coating further comprises a binder which binds the composite particulate material to the article.

The binder can be any material or combination of materials that is capable of binding the composite particular material to the article, and the most appropriate binder will vary depending on the particular application. For example, the binder can be an adhesive or adhesive material. In particular, the binder can be double-sided tape, glue, silicone or paint (including primers). In some embodiments, the binder is a polymer such as high density polyethylene (HDPE), low density polyethylene (LDPE), polyethylene terephthalate (PET), polyvinyl acetate (PVA), polyvinyl chloride (PVC), polypropylene (PP), polydimethylsiloxane (PDMS) or polystyrene (PS).

In preferred embodiments, the binder may be a resilient material. This provides some advantages in terms of the resistance of the overall coating to damage by physical abrasion because the resilient nature of the binder may allow the composite particulate material to move a small amount relative to the surface and recoil without detaching from the surface after and deforming force is removed.

The lubricant can be a liquid, solid, semi-solid or a compound that is thixotropic in nature. For example, the lubricant can be an oily liquid or a grease. In preferred embodiments, the lubricant is a fluorinated or partially fluorinated hydrocarbon. For example, the lubricant can be an organofluorine compound, such as a fluorocarbon polymer, which are also known as perfluoropolyethers (PFPE) or perfluoropolyalkylethers (PFPAE) or a polymer which has a chain comprising carbon, silicon and fluorine atoms. According to some embodiments, the lubricant can be a functionalised hydrocarbon (including alkane, alkene, alkyne and aromatic hydrocarbons), such as a hydrocarbon functionalised with an ether, ketone, aldehyde, cyanide, halide, amide, amine, or ester. In preferred embodiments, the lubricant is a fluorosilane, perfluorosilane, perfluoroalkylether or mixtures thereof. In some embodiments, the lubricant can be a solid, for example a particulate solid, such as graphite powder, MoS₂, hexagonal boron nitride, WS₂, or polytetrafluoroethylene (PTFE). In these embodiments, the particulate solid may have a particle size of less than about 500 μm, less than about 250 μm, less than about 100 μm, less than about 10 μm, less than about 1 μm, less than about 500 nm, less than about 250 nm, less than about 100 nm, or less than about 25 nm. In some embodiments, the lubricant may be a wax, including animal waxes, plant waxes such as carnuba wax, and paraffin waxes.

The viscosity of the lubricant can be between about 0.50 cSt and 110000 cSt at 20° C. In some embodiments, the lubricant can have a viscosity of between about 1 and 90000, about 2 and 80000, about 3 and 70000, about 4 and 60000, about 5 and 50000, about 6 and 40000, about 7 and 30000, about 8 and 20000 or about 9 and 10000 cSt at 20° C. In certain embodiments, the lubricant has a viscosity of between about 10 and 1600, about 20 and 1200, about 30 and 1000, about 40 and 750, about 50 and 500, about 60 and 250, or about 70 and 200 cSt at 20° C. In particularly preferred embodiments, the lubricant has a viscosity of about 12.4, 17.4, 38, 82, 177, 522, 822 or 1535 cSt at 20° C.

Preferably, the lubricant is 3M FC-70, a grade of DuPont Krytox oily liquid, silicon oil or an equivalent thereof. Particularly preferred grades are Krytox 100B, Krytox 101, Krytox 103, Krytox 104, Krytox 104A, Krytox 105, Krytox 106, and Krytox 107 and equivalents thereof.

In the coatings of the present invention, the lubricant is substantially immobilised on the composite particulate material. In this way, the lubricant is physically attracted to the surface of the composite particulate material, e.g. by standard surface interactions such as Van der Waals forces between the lubricant and the surface of the composite particulate material, or by capillary action retaining the lubricant in crevices or surface deformations on or between the composite particulate material. Typically, the strength of this immobilisation may increase with increasing surface area to volume ratio of the composite particulate material. That is a composite particulate material using carrier particles having a rough surface, i.e. a high surface area to volume ratio, may be preferred to immobilise the lubricant more strongly. This immobilisation is desirable because it means that the SLIPS surface has a longer lifetime.

In some cases, where a sufficient amount of lubricant is present at the surface, the lubricant is immobilised at the surface of the composite particulate material but regions of the lubricant that are not near to the surface of the composite particulate material may be able to flow across the surface of the coating. The amount of flow may depend on a number of factors such as the strength of the surface interaction between the lubricant and the composite particulate material, the viscosity of the lubricant, the temperature etc. In some preferred embodiments, the lubricant can flow across the coating while the regions near to the composite particulate material may be locally immobilised.

In the present invention, the lubricant penetrates into the layer of composite particulate material. That is distinct from just coating the top surfaces of the particulate material in the particulate layer; in the present invention the lubricant penetrates between the particles of the particulate layer which results in a higher contact area between the surface of the composite particulate material and the lubricant and, consequently, an improved immobilisation of the lubricant on the composite particulate layer as compared to a lubricant that is only coated on the top surfaces of the particles.

In some embodiments, the amount of lubricant per unit area of the coated surface may be between about 1 mg/cm² and about 500 mg/cm², preferably between about 1 mg/cm² and about 250 mg/cm², preferably between about 1 mg/cm² and about 150 mg/cm², preferably between about 2 and about 100, preferably between about 3 and about 75, preferably between about 4 and about 50 mg/cm².

Similarly, the amount of lubricant may be determined according to the thickness of the coating on the surface. In some embodiments, the thickness on the surface may be between about 10 nm and about 500 μm, preferably between about 50 nm and about 500 μm, preferably between about 100 nm and about 500 μm, preferably between about 1 μm and about 500 μm, preferably between about 5 μm and about 500 μm, preferably between about 10 μm and about 300 μm, preferably between about 15 μm and about 200 μm, preferably between about 40 μm and about 200 μm.

The material of the article will depend upon the intended application of the coating. Advantageously, it has been found that the composite particulate material can be bound to articles that are made from a variety of materials including natural, naturally-derived and synthetic materials. For example, the article may be glass, metal, stone, plastic or a cellulose-based material, such as wood, paper or card. The article may also be a fabric or textile, such as wool, cotton or cloth. The article may have a smooth, textured or rough surface morphology. For example, the article may comprise a plurality of projecting nano and/or microstructures. Such articles may include highly textured or abrasive materials, such as abrasive papers (e.g. sandpaper).

The coatings described herein define a slippery surface, which may repel both water and oils and thus be described as amphiphobic surfaces. Mixtures comprising both aqueous and oily liquids may also be repelled by the slippery surface. The degree of repulsion depends upon the amphiphobicity of the surface. A liquid contacting an amphiphobic surface can form droplets and the greater the degree of repulsion between the amphiphobic surface and the liquid, the more spherical the droplets will be. Liquid contaminants that are not repelled by the amphiphobic surface will tend to spread out and “wet” the surface.

The wettability of a surface is often defined according to the contact angle of a liquid droplet deposited on the surface. The contact angle may be defined as the angle created where the liquid interface meets the solid interface. For water, a surface is hydrophobic if water form droplets having contact angles of greater than about 90 degrees. On the other hand, a surface may be described as hydrophilic if water forms droplets having contact angles of less than 90 degrees. Where the contact angle is between 0 and 10 degrees, the surface can be described as superhydrophilic. Water contacting a superhydrophobic surface will form droplets that have contact angles of at least 150 degrees.

Both water and oily liquids contacting the slippery surface defined by the coatings described herein may form droplets which have a contact angle of from about 50 to about 150 degrees.

The slippery nature of the surface may be described according to the ease by which liquid droplets move on the surface, which can be defined by the contact angle hysteresis of the droplets. Droplets that have a low contact angle hysteresis move more easily on a surface than droplets that have a high contact angle hysteresis. As is well known in the art, a liquid droplet on a surface will have a spectrum of contact angles ranging from the so-called advancing (maximal) contact angle (defined as θ_{A}), to the so-called receding (minimal) contact angle (θ_{B}). The contact angle hysteresis can be defined as θ_{A}-θ_{B}. Two common methods of measuring the contact angle hysteresis are tilting-plate goniometry (TPG) and captive-drop goniometry (CDG) (see Krishnan et al., Colloids and Surf, B: Biointerfaces, 2005, 43, 95).

Slippery surfaces have a contact angle hysteresis of less than about 15 degrees. If the contact angle hysteresis is greater than this, the surface can no longer be described as slippery because liquid droplets will not readily slip on the surface. The contact angle hysteresis of droplets formed on the coatings described herein can be between about 0.05 and 15, between about 1 and 15, between about 2 and 14, between about 3 and 13, between about 4 and 12, between about 5 and 11, between about 6 and 10 or between about 7 and 9 degrees.

The coatings of the invention are substantially robust. That is to say, they continue to exhibit slippery properties even after being subject to relatively harsh conditions. For example, the coatings maintain their slippery properties even after being mechanically abraded or exposed to high temperatures. As demonstrated by the Examples, the coatings are also extremely durable and maintain their slippery properties even after the application of heat and significant evaporation of the lubricant. This durability and robustness is thought to come about as a result of the specific combination of the layer of robust, bound composite particulate material and the immobilised lubricant. Furthermore, contaminants deposited on the coating can easily be removed by the sliding action of liquid droplets on the slippery surface, which may thus be described as self-cleaning surfaces.

According to a second aspect of the invention there is provided a method of preparing a coating defining a slippery surface on an article comprising, binding a composite particulate material to the article to form a superhydrophobic layer on the article, and applying a lubricant to said layer such that the lubricant at least partially covers said particulate material and penetrates at least partially into said layer. The composite particulate material can comprise carrier particles at least partially coated with a hydrophobic material.

In some embodiments, the composite particulate material may be a composite particulate material according to the first aspect of the invention. The composite particulate material can be applied to the article by any suitable means. For example, the composite particulate material can be applied by sprinkling, dropping, smearing, spreading, brushing, rolling or spraying it onto the article. In some embodiments, the composite particulate material is applied using a powder coating process. Alternatively, the composite particulate material may first be processed into a substantially solid cylindrical stick-like form which may then be rolled onto the article. The rolling action deposits a layer of the composite particulate material onto the article.

The composite particulate material may be bound to the article by any suitable means. Optionally, in some embodiments, the method may further comprise applying a binder to the article. The binder can be an adhesive according to the first aspect of the invention. The binder can be applied to the article by any suitable means, but the most appropriate means will depend, to a large extent, upon the particular properties of the binder (for example, its viscosity or tackiness). Suitable methods for applying the binder to the article include smearing, spreading or spray coating, for example. Conveniently, where the binder is double-sided tape, the tape may simply be rolled onto the article.

Where the method comprises applying a binder to the article, the method comprises:
applying a binder to the article;
applying composite particulate material to the binder to form a superhydrophobic layer bound to the article; and
applying a lubricant to said layer.

The particular order of applying the binder and composite particulate material to the article may be varied. For example, the binder may first be applied to the article and then the plurality of composite particulate material applied to the binder.

In some embodiments, the method comprises the steps of:
applying the binder to the article;
applying the composite particulate material to the article; and
applying the lubricant to the article.

Alternatively, the method can comprise combining the binder with the composite particulate material to form a mixture and then applying the mixture to the article. In some embodiments, the composite particulate material is applied to the article concomitantly or with the binder. For example, composite particulate material comprising silicon dioxide can be applied with PDMS. In some embodiments, the lubricant may be combined with or applied to the composite particulate material which is subsequently applied as a layer to a surface of the article, in some cases using a binder. As for the other embodiments, if used, the binder may be applied to the surface of the article before application of the combined lubricant and composite particulate material, or the binder may be combined with the lubricant/composite particulate material combination and subsequently applied to the surface of the article.

Upon binding the composite particulate material to the article a layer is formed defining a surface that can comprise many nano and/or microstructures. Prior to the addition of the lubricant, the layer of composite particulate material is extremely water repellent, exhibiting superhydrophobic properties. It can thus be described as a superhydrophobic layer.

The term “superhydrophobic” can be used to describe surfaces which are exceptionally hydrophobic and hence extremely resistant to wetting. Superhydrophobic surfaces typically comprise a complex array of micro and nanostructures which provide for the formation of many chambers or pockets, such as cavities, pores and voids. Water is unable to penetrate into these pockets owing to its relatively high surface tension. Thus, when water droplets form on the surface, pockets of air become trapped between the surface and the droplet, thus reducing contact between the water and the surface. The more the contact between the water droplet and the surface can be reduced, the greater the hydrophobicity of the surface.

Rather than characterising superhydrophobic surfaces according to their specific chemical and/or physical properties, it can be more convenient to characterise them according to the contact angle that is formed by a water droplet on the surface. Prior to the application of the lubricant, the layer of composite particulate material can have a contact angle of between about 150 and about 180 degrees.

The lubricant can be a lubricant according to the first aspect. The most appropriate method of applying the lubricant will depend, at least in part, upon on the viscosity of the lubricant. However, it is important to ensure that the lubricant at least partially covers and penetrates into the layer of composite particulate material. The lubricant is able to penetrate into the superhydrophobic layer of composite particulate material because it has a lower surface tension than water. That is to say, the lubricant can infiltrate the pockets formed by the micro and nanostructures and become immobilised, forming the coating.

Lubricants having a low viscosity may be applied by dropping them onto the article, whereas lubricants having a high viscosity, such as greases, may be applied by smearing them onto the article. Where the lubricant has a high viscosity it may be necessary to heat the article or lubricant first. The heating encourages the lubricant to melt, thus lowering its viscosity and enabling it to evenly coat the article. In particular embodiments, the lubricant can be dropped onto the superhydrophobic layer using a syringe. The lubricant can also be applied by a dipping the superhydrophobic layer in the lubricant or spraying the lubricant onto the superhydrophobic layer.

The intended use of the coating may also have a bearing on the choice of lubricant. For example, the inventors have found that it is possible to switch between the slippery (amphiphobic) coating and the superhydrophobic layer by heating the article and evaporating the lubricant. In such instances, it is desirable to use a lubricant with a higher volatility. Optionally, the lubricant can then be replaced, thus reforming the slippery coating.

The method of preparing the coating is operationally simple and the composite particulate material itself is also straightforward to manufacture and manipulate. It can therefore be bound to articles which are made from a variety of different materials and have a variety of shapes.

According to a third aspect of the invention an article is provided which is prepared according to the method of the second aspect.

According to a fourth aspect of the invention an article according to the first aspect is provided which is prepared according to the method of the second aspect.

According to a fifth aspect, an article is provided which is useful for preparing an article of the first aspect. This article of the fifth aspect is at least partially covered with a coating comprising a layer of composite particulate material bound to said article wherein the composite particulate material comprises carrier particles at least partially coated with a hydrophobic material. The articles of this fifth aspect are useful for preparing an article of the first aspect by exposure of the coating to a lubricant as defined in the first aspect. When the coating is exposed to the lubricant, the lubricant penetrates into the layer of composite particulate material and becomes immobilised in the coating.

In the fifth aspect, the composite particulate material comprises, or consists of, two particle populations having different average particle sizes, e.g. as defined above. In particular, the composite particulate material preferably comprises a first particulate population having a relatively larger average particle size of between about 100 nm and about 2000 μm. and a second particulate population having a relatively smaller average particle size of between about 10 nm and about 1 μm. In some preferred embodiments of the fifth aspect, the particulate material further comprises a third particle population having a further different intermediate average particle size, such as an average particle size of between about 50 nm and about 100 μm.

Methods of forming an article of the fifth aspect also form part of the present disclosure.

According to a sixth aspect, a coating composition, in some cases a powder, e.g. a dry powder, is provided which is useful in the preparation of an article of the first aspect. This coating composition comprises a lubricant as defined herein combined with a composite particulate material as defined herein. The composite particulate material may comprise carrier particles at least partially coated with hydrophobic material as defined herein. The lubricant is substantially immobilised on the composite particulate material. When applied as a layer to a surface of an article, this coating composition forms a slippery surface as defined herein. In some cases a binder may be used when applying the coating composition to the surface of the article.

Methods of forming a coating composition of the sixth aspect also form part of the present disclosure.

The coatings described herein represent a significant advance in the field. In particular, the coatings described herein are substantially more durable and robust than existing SLIPS. That is to say, the coatings maintain at least some of their properties, even after being exposed to relatively harsh conditions, such as high temperatures, impacts and abrasions.

### BRIEF DESCRIPTION OF FIGURES

For the purposes of example only, embodiments of the invention are described below with reference to the accompanying drawings, in which:

FIGS. 1 and 2 are graphs which are referred to in the Examples.

FIG. 3 is a table which includes the data used for the graphs of FIGS. 1 and 2

FIG. 4 is a selection of scanning electron micrographs of some of the carrier particles referred to herein.

### EXAMPLES

### Example 1

Fabrication of Composite Particulate Material

According to a general method, the hydrophobic material was combined with the carrier liquid and the resultant mixture was stirred until a solution was formed. Carrier particles were then added to the solution and the resultant mixture was stirred until substantially all of the carrier particles were coated with the solution. The mixture was filtered and the carrier liquid was removed via evaporation to provide the composite particulate material.

Composite particulate material A: 1 wt. % perfluorooctyltriethoxysilane in ethanol base (FAS) was stirred for 2 hours. Particles of MnO (−60 mesh) were then added to the mixture. The carrier liquid was allowed to evaporate overnight.

Composite particulate material B: 1 wt. % perfluorooctyltriethoxysilane in ethanol base (FAS) was stirred for 2 hours, and then particles of Nb₂O₅ (−325 mesh) were treated with FAS. The carrier liquid was allowed to evaporate overnight.

Composite particulate material C: 1 wt. % perfluorooctyltriethoxysilane in ethanol base (FAS) was stirred for 2 hours, and then particles of TiO₂ nanoparticles (sizes range from about 20 to about 300 nm, as determined by SEM) were treated with FAS. The carrier liquid was allowed to evaporate overnight.

Composite particulate material D: 1 wt. % perfluorooctyltriethoxysilane in ethanol base (FAS) was stirred for 2 hours, and then particles of TiO₂ P25 (average primary particle size 21 nm) were treated with FAS. The carrier liquid was allowed to evaporate overnight.

### Example 2

Method of Binding the Layer of Composite Particulate Material to the Article & Durability Tests

Three coatings were prepared by fixing composite particles of MnO, Nb₂O₅, iron oxide (the carrier particles) and stearic acid (the hydrophobic material), on glass substrates using double-sided tape.

Measurement of Contact Angles of the Superhydrophobic Layer

The contact angles were measured at ambient temperature using the sessile-drop method using an optical contact angle meter (FTA 1000, Surftens 4.5, water droplet is 5 μL).

Measurement of the Durability of the Composite Particulate Layer

The coatings were then exposed to ultraviolet radiation having a wavelength of 365 nm and 254 nm. The UV light was fully covered and positioned nearly in contact with the samples for a period of 24 hours and then water contact angle (CA) was measured. The results are shown in table 1.

TABLE 1

| | MnO + | Nb₂O₅ + | Iron oxide + |
|---|---|---|---|
| Composite Material | stearic acid | stearic acid | stearic acid |
| CA Before UV tests | 151.1 | 154.8 | 153.3 |
| CA after 365 nm UV | 150.1 | 152.3 | 150.3 |
| tests | | | |
| CA after 254 nm UV | 150.7 | 150.0 | 150.3 |
| tests | | | |

As can be seen from Table 1, all of the layers were superhydrophobic before the UV tests, having contact angles of >150 degrees. After exposure to ultraviolet radiation at two different wavelengths the layers remained superhydrophobic. This demonstrates that the superhydrophobic layer is robust enough to withstand high-energy UV radiation.

### Example 3

Fabrication of Coated Articles

Double-sided adhesive tape was applied to a glass side and then the composite particulate material was applied to the surface of the adhesive tape. The lubricant was then dropped onto the layer of the composite particulate material until the lubricant fully covered and penetrated into the layer of composite particulate material.

Durability Tests of Coated Article

Substrate area: 25 mm×25 mm SLIPS comprising composite particulate material (carrier particles of TiO₂ having a primary size of approximately 21 nm mixed with TiO₂ having a size range of between about 20 nm and 300 nm coated with perfluorooctyltriethoxysilane) and the lubricant Krytox 104A.

The mass (g) of the substrate was measured before and after the addition of the lubricant. The substrate was heated to 98° C. (±2° C.) and the mass (g) of the substrate was measured every 5 min. The results are shown in table 2.

TABLE 2

| Lubricant | Krytox 104A |
|---|---|
| Mass before addition of | 4.5239 |
| lubricant | |
| Mass after addition of | 4.7543 |
| lubricant | |
| Mass after 5 min | 4.6659 |
| Mass After 10 min | 4.6314 |
| Mass After 15 min | 4.5908 |
| Mass After 20 min | 4.5862 |
| Mass After 25 min | 4.5659 |
| Mass After 30 min | 4.5590 |
| Mass After 35 min | 4.5532 |

The results in Table 2 show that the coated article continued to maintain an amount of the lubricant even after 35 minutes of heating.

The average thickness (μm) of the lubricant layer on the surface was calculated from the mass data in Table 2 and knowledge of the density of the lubricant and the area of deposition. The average thickness of the lubricant layer is shown in Table 3.

| Lubricant | Krytox 104A |
|---|---|
| Thickness after addition of | 199.0 |
| lubricant (μm) | |
| Thickness (μm) after 5 min | 122.6 |
| Thickness (μm) After 10 min | 92.8 |
| Thickness (μm) After 15 min | 57.8 |
| Thickness (μm) After 20 min | 53.8 |
| Thickness (μm) After 25 min | 36.3 |
| Thickness (μm) After 30 min | 30.3 |
| Thickness (μm) After 35 min | 25.3 |

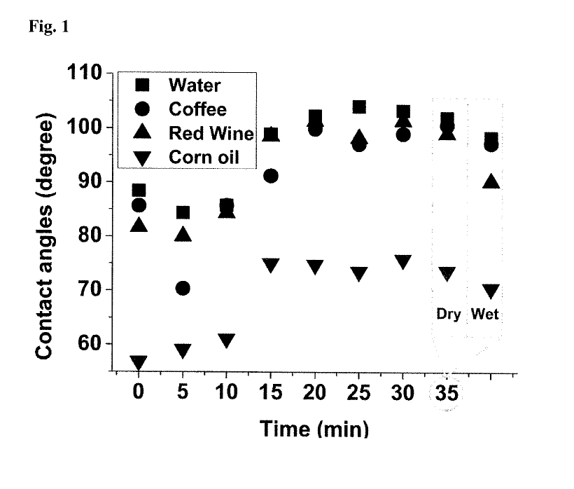

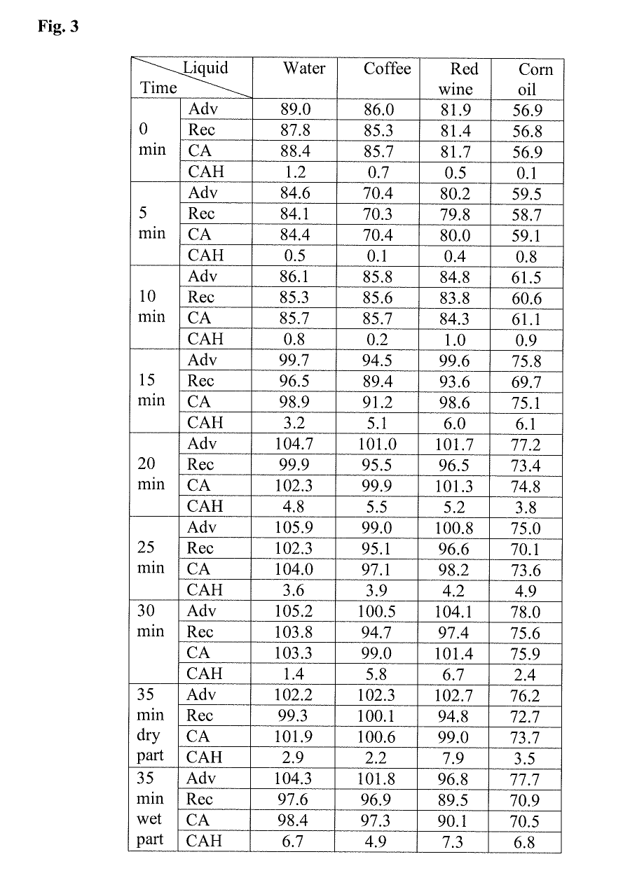

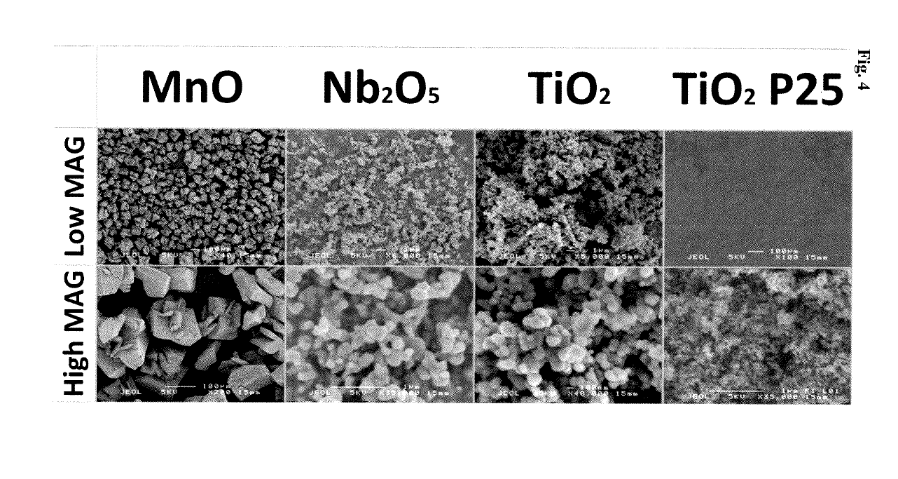

In order to further demonstrate the durability of the coated article, the liquid contact angle (CA) and contact angle hysteresis (CAH) of the sample was measured at intervals during the heating process. Tilting grade goniometry (TPG) was used to measure the CAH. The results are presented in FIGS. 1 to 3.

The sample was positioned on a hot plate (set to about 100° C.). Every 5 minutes, the sample was removed from the hot plate, allowed to cool to ambient temperature, and the CA and CAH of water, coffee, red wine and corn oil droplets were measured.

As seen in FIG. 1, from 0 to 10 min heating, the CA gradually increased, and then jumped to a high level between 10 and 15 min, before stabilising between 15 and 30 min. After heating for 35 min the lubricant no longer evenly covered the substrate; there appeared to be “wet” regions (regions that appeared to still be coated in the lubricant) and “dry” regions (regions where the lubricant appeared to have evaporated from). Thus, at 35 min the contact angle measurements were taken from both the wet and dry regions and the results compared. As can be seen, the CA did not change much between dry and wet regions, which shows that even regions that appeared dry still comprised a thin layer of the lubricant, thus maintaining the slippery property.

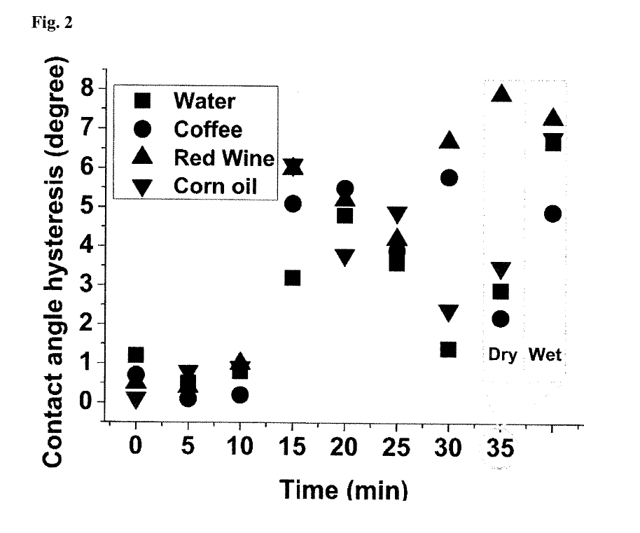

FIG. 2 shows that even areas that appeared to be dry after 35 min heating still exhibited a CAH of below 10 degrees. However, it was observed that the sliding motions of liquids were getting slower as the heating time increased. These results demonstrate the durability of the coating and that it maintains its slippery properties, even when the lubricant has been substantially evaporated.

From the heating tests, it can be concluded that the coating retains its slippery properties (as shown by the CA measurements and the CAH of <15 degrees), even after being heated at 100° C. This demonstrates that coated articles may be fabricated which are durable enough to still function as liquid repellent substrates, even after sustained exposure to high temperatures.

### Example 4

Low-Temperature Test

An article according to the first aspect of the invention comprising composite particulate material (nanoscale titanium dioxide carrier particles and perfluorooctyltriethoxysilane as the hydrophobic material) and a lubricant (Krytox FC 70) was inserted into liquid nitrogen (about −196° C.) for about 3 s, and then coffee, red wine, corn oil and water were dropped on the surface. Initially, all of the liquids were immobilised on the surface of the article. Then, as the surface returned to room temperature, it reverted back to its slippery form and the liquids were repelled. This demonstrates that the coatings described herein are not damaged when subjected to extremely cold temperatures and, upon returning to ambient temperate, still function as slippery surfaces.

### REFERENCES

1. Leslie et al., Nat. Biotechnol., 2014, 32, 1134.
2. Grinthal et al., Chem. Mater., 2014, 26, 698.
3. Kim et al., Nano Lett., 2013, 13, 1793.
4. MacCallum et al., ACS Biomater. Sci. Eng., 2015, 1, 43.
5. Wilson et al., Phys. Chem. Chem. Phys., 2013, 15, 581.

1. An article at least partially covered with a coating defining a slippery surface, the coating comprising a layer of a composite particulate material bound to said article and a substantially immobilized lubricant at least partially covering and penetrating into said layer of composite particulate material, wherein the composite particulate material comprises carrier particles at least partially coated with a hydrophobic material.

2. An article according to claim 1, wherein the coating further comprises a binder and wherein the composite particulate material is bound to the article by said binder.

3. An article according to claim 2, wherein the binder is an adhesive.

4. An article according to claim 2, wherein the binder is a polymer.

5. An article according to claim 1, wherein the composite particulate material is a powder or a granular material.

6. An article according to claim 1, wherein the carrier particles have recess defining surface irregularities and the hydrophobic material is located at least partially within some or all of the recesses defined by said surface irregularities.

7. An article according to claim 1, wherein the carrier particles comprise or consist of a natural or synthetic mineral, a metal, metal alloy, metal oxide, or metal salt, or a mixture or composite of any of these.

8. An article according to claim 1, wherein the carrier particles comprise aluminium, chromium, cobalt, copper, iron, manganese, silver, tin, niobium, titanium, lead, nickel, zinc, molybdenum, beryllium, boron, phosphorus, arsenic or silicon, preferably in the form of or within an oxide, mixture, alloy, natural or synthetic mineral or composite.

9. An article according to claim 1, wherein the hydrophobic material comprises a silane, fluorosilane, perfluorosilane, organosilicon compound (including silicones and polymerised siloxanes), fluorocarbon, perfluorocarbon, polymer comprising carbon, silicon and fluorine atoms, fluorinated carboxylic acid or ester, perfluorinated carboxylic acid or ester, fatty acid, or fatty ester (including mono-, di and triglycerides), a derivative or salt thereof, or a mixture of any of these.

10. An article according to claim 1, wherein the hydrophobic material comprises perfluorooctyltriethoxysilane, lauric acid, myristic acid, palmitic acid, stearic acid, perfluorooctanoic acid, a derivative or salt thereof, or a mixture of any of these.

11. An article according to claim 1, wherein the lubricant has a viscosity of between about 0.5 cSt to about 110000 cSt at 20° C.

12. An article according to claim 1, wherein the lubricant is an at least partially fluorinated hydrocarbon, a fluorosilane, perfluorosilane, perfluoroalkylether, silicone oil, or a mixture of any of these.

13. An article according to claim 1, wherein the composite particulate material comprises three populations of carrier particles each having different average particle sizes, at least one population of the carrier particles being at least partially coated with a hydrophobic material.

14. An article according to claim 13, wherein the three populations of carrier particles have respective particle sizes in the three size ranges: between about 100 nm and about 2000 μm; between about 50 nm and about 100 μm; and between about 10 nm and about 50 μm.

15. An article according to claim 14, wherein the three populations of carrier particles comprise:
MnO particles having an average particle size in the range about 100 μm to about 1000 μm;
Fe particles having an average particle size in the range about 10 μm up to about 100 μm;
Nb₂O₅ or Ta₂O₅ particles having an average particle size in the range about 10 nm to about 50 μm.

16. An article at least partially covered with a coating comprising a layer of composite particulate material bound to said article, wherein the composite particulate material comprises three populations of carrier particles each having different average particle sizes, at least one population of the carrier particles being at least partially coated with a hydrophobic material; said article being suitable for use in preparation of an article according to any one of the preceding claims.

17. An article according to claim 16, wherein the three populations of carrier particles have respective particle sizes in the three size ranges: between about 100 nm and about 2000 μm; between about 50 nm and about 100 μm; and between about 10 nm and about 50 μm.

18. An article according to claim 17, wherein the three populations of carrier particles comprise:
MnO particles having an average particle size in the range about 100 μm to about 1000 μm;
Fe particles having an average particle size in the range about 10 μm up to about 100 μm;
Nb₂O₅ or Ta₂O₅ particles having an average particle size in the range about 10 nm to about 50 μm.

19. A method of preparing a coating defining a slippery surface on an article comprising, binding a composite particulate material to the article to form a superhydrophobic layer on the article, and applying a lubricant to said layer such that the lubricant at least partially covers said particulate material and penetrates at least partially into said layer.

20. A method according to claim 19, wherein the composite particulate material comprises carrier particles at least partially coated with a hydrophobic material.

21. A method according to claim 19, wherein the method further comprises applying a binder to the article.

22. A method according to claim 21, wherein the binder is an adhesive.

23. A method according to claim 21, wherein the binder is a polymer.

24. A method according to claim 21 comprising:
applying a binder to the article;
applying the composite particulate material to the binder to form a superhydrophobic layer bound to the article; and
applying a lubricant to said layer.

25. A method according to claim 21 comprising:
combining the composite particulate material with the binder to form a mixture;
applying said mixture to the article to form a superhydrophobic layer bound to the article; and
applying a lubricant to said layer.

26. A method of preparing a coating defining a slippery surface on an article, the method comprising combining a lubricant with a composite particulate material, and applying a layer of the combined lubricant and composite particulate material to a surface of the article to form a slippery surface wherein the lubricant is substantially immobilized and at least partially covering and penetrating into said layer of composite particulate material.

27. A method according to claim 26, wherein the composite particulate material comprises carrier particles at least partially coated with a hydrophobic material.

28. A method according to claim 26, wherein the composite particulate material is a powder or a granular material.

29. A method according to claim 27, wherein the carrier particles have recess defining surface irregularities and the hydrophobic material is located at least partially within some or all of the recesses defined by said surface irregularities.

30. A method according to claim 27, wherein the carrier particles comprise or consist of a natural or synthetic mineral, a metal, metal alloy, metal oxide, or metal salt, or a mixture or composite of any of these.

31. A method according to claim 27, wherein the carrier particles comprise aluminium, chromium, cobalt, copper, iron, manganese, silver, tin, niobium, titanium, lead, nickel, zinc, molybdenum, beryllium, boron, phosphorus, arsenic or silicon, preferably in the form of or within an oxide, mixture, alloy, natural or synthetic mineral or composite.

32. A method according to claim 27, wherein the hydrophobic material comprises a silane, fluorosilane, perfluorosilane, organosilicon compound (including silicones and polymerised siloxanes), fluorocarbon, perfluorocarbon, polymer comprising carbon, silicon and fluorine atoms, fluorinated carboxylic acid or ester, perfluorinated carboxylic acid or ester, fatty acid, or fatty ester (including mono-, di and triglycerides), a derivative or salt thereof, or a mixture of any of these.

33. A method according to claim 27, wherein the hydrophobic material comprises perfluorooctyltriethoxysilane, lauric acid, myristic acid, palmitic acid, stearic acid, perfluorooctanoic acid, a derivative or salt thereof, or a mixture of any of these.

34. A method according to claim 26, wherein the lubricant has a viscosity of between about 0.5 cSt to about 110000 cSt at 20° C.

35. A method according to claim 26, wherein the lubricant is an at least partially fluorinated hydrocarbon, a fluorosilane, perfluorosilane, perfluoroalkylether, silicone oil, or a mixture of any of these.

36. A method according to claim 26, wherein the composite particulate material comprises three populations of carrier particles each having different average particle sizes, at least one population of the carrier particles being at least partially coated with a hydrophobic material.

37. A method according to claim 36, wherein the three populations of carrier particles have respective particle sizes in the three size ranges: between about 100 nm and about 2000 μm; between about 50 nm and about 100 μm; and between about 10 nm and about 50 μm.

38. A method according to claim 37, wherein the three populations of carrier particles comprise:
MnO particles having an average particle size in the range about 100 μm to about 1000 μm;
Fe particles having an average particle size in the range about 10 μm up to about 100 μm;
Nb₂O₅ or Ta₂O₅ particles having an average particle size in the range about 10 nm to about 50 μm.

39-42. (canceled)
